(19) United States
(12) Patent Application Publication
(10) Pub. No.: US 2025/0134112 A1
(43) Pub. Date: May 1, 2025

(54) OVEN READY TRAY

(71) Applicant: Hormel Foods Corporation, Austin, MN (US)

(72) Inventors: Daniel L. Vierkandt, Clear Lake, IA (US); Jeffrey J. Wallace, Rochester, MN (US); Nicholas G. Schweitzer, Austin, MN (US); Kelsey M. Hedlof, Spicer, MN (US)

(21) Appl. No.: 18/810,659

(22) Filed: Aug. 21, 2024

Related U.S. Application Data
(60) Provisional application No. 63/545,583, filed on Oct. 25, 2023.

(51) Int. Cl. A21B 3/13

(52) U.S. Cl. CPC A21B 3/131

(57) ABSTRACT

An oven ready tray for use in cooking meat comprises a tray bottom and at least two depressions extending downward from the tray bottom. The at least two depressions are configured and arranged to collect liquid generated during cooking of meat to contact portions of the meat with liquid without submerging the meat in liquid. An oven ready tray assembly includes meat positioned on the tray bottom. A method of cooking meat includes placing the tray on which the meat is positioned in an oven, cooking the meat on the tray in the oven to generate liquid, the at least two depressions collecting liquid generated during cooking, and contacting the meat with liquid collected in the at least two depressions during cooking.

### CROSS-REFERENCE TO RELATED APPLICATION

This application claims the benefit of Provisional Patent Application Ser. No. 63/545,583, filed Oct. 25, 2023, and entitled “OVEN READY TRAY,” the disclosure of which is hereby incorporated by reference in its entirety.

### BACKGROUND

Meat can be cooked using a variety of cooking methods. For example, raw bacon slices can be fried in a pan on a cooktop, baked on a baking sheet in an oven, and cooked on a plate in a microwave oven. In each of these cooking methods, consumers place raw bacon slices on the pan, sheet, or plate, and many consumers do not like to handle raw meat. In addition, cleanup after cooking can be messy.

### SUMMARY

For the reasons stated above and for other reasons stated below, which will become apparent to those skilled in the art upon reading and understanding the present specification, there is a need in the art for an oven ready tray.

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an oven ready tray for use in cooking meat comprises a tray bottom and at least two depressions extending downward from the tray bottom. The at least two depressions are configured and arranged to collect liquid generated during cooking of meat to contact portions of the meat with liquid without submerging the meat in liquid.

In one embodiment, an oven ready tray assembly comprises a tray and meat. The tray includes a tray bottom and at least two depressions extending downward from the tray bottom. The meat is positioned on the tray bottom.

In one embodiment, a method of cooking meat comprises removing a tray from packaging, the tray including at least two depressions extending downward from a bottom of the tray, meat positioned on the bottom of the tray and extending over the at least two depressions, placing the tray in an oven, cooking the meat on the tray in the oven to generate liquid, the at least two depressions collecting liquid generated during cooking, and contacting the meat with liquid collected in the at least two depressions during cooking.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is an isometric view of an embodiment of an oven ready tray assembly, in accordance with one or more examples of this disclosure;

FIG. 2 is a top view of an embodiment of a tray constructed in accordance with one or more examples of this disclosure;

FIG. 3 is a cross-section view of an embodiment of the tray shown in FIG. 2 taken along the lines 3-3, in accordance with one or more examples of this disclosure;

FIG. 4 is a cross-section view of an embodiment of the tray shown in FIG. 2 taken along the lines 4-4, in accordance with one or more examples of this disclosure;

FIG. 5 is a top view of an embodiment of a tray blank, in accordance with one or more examples of this disclosure;

FIG. 6 is an elevated view of an embodiment of a stack of the trays shown in FIG. 2, in accordance with one or more examples of this disclosure;

FIG. 7 is a top view of an embodiment of the tray shown in FIG. 2 with meat positioned thereon, in accordance with one or more examples of this disclosure;

FIG. 8 is a cross-section view of an embodiment of the tray shown in FIG. 7 with meat positioned on the tray taken along the lines 8-8, in accordance with one or more examples of this disclosure;

FIG. 9 is a top view of an embodiment of the oven ready tray assembly of FIG. 1, in accordance with one or more examples of this disclosure; and

FIG. 10 is an elevated view of an embodiment of the oven ready tray assembly of FIG. 1 shown in a stacked formation, in accordance with one or more examples of this disclosure.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide an oven ready tray that allows meat positioned on an oven-safe tray to be unpackaged and cooked in an oven, preferably without contacting the meat, and allows for easy cleanup after cooking. The tray may be made of any suitable oven-safe material that is preferably disposable and/or recyclable and includes a sidewall with a lip and at least two depressions or wells configured and arranged to collect liquid (e.g., grease, fat, water) generated during cooking, the meat to be cooked in the oven, and a protective film to protect the meat until it is time to cook.

The tray can also include sides to help contain any liquid not collected in the depressions or wells. The sides of the tray may extend upwardly and slightly outwardly to allow for nesting of multiple trays for display and/or transportation. In some embodiments, the depressions or wells of the tray are parallel to a longitudinal axis of the tray and meat is positioned generally perpendicular to the longitudinal axis of the tray thereby extending over the depressions or wells. In some embodiments, the depressions or wells are configured and arranged so that the meat contacts at least some of the liquid generated during cooking without submerging the meat in liquid. Optionally, the meat and tray assembly is covered by a protective film, either on one or both sides of the tray, and the protective film is easily removed prior to cooking. In some embodiments, the protective film is vacuum sealed to the meat and exposed portions of the bottom of the tray to allow for nesting of multiple trays within one another for display and/or transportation.

After the optional protective film is removed, the tray on which the meat is positioned is simply placed in an oven. During cooking, the meat generates liquid, and because the depressions or wells are configured and arranged to collect the liquid generated during cooking, at least some portions of the meat contact the liquid during cooking without submerging the meat in the liquid. Contact with the liquid assists in even cooking of the meat. In some embodiments, the even cooking of the meat allows the meat to cook without flipping or otherwise moving the meat and results in a relatively uniform appearance. After cooking, the tray (including the meat) is removed from the oven and then the meat is removed from the tray. In some embodiments, the liquid is positioned in the depressions or wells to separate the liquid into smaller portions which prevents the liquid from forming large swells or waves which may rise higher than the height of the sides of the tray when removing from the oven. Some of the liquid could be positioned on the bottom of the tray and the tray includes sides that are tall enough to further reduce the risk of spilling any liquid as the tray is removed from the oven.

The tray, including liquid generated during cooking, can be left to cool to room temperature and then discarded in the garbage. If the liquid is grease or fat, the grease or fat will at least partially solidify or congeal at room temperature thereby allowing for easy clean up by simply discarding the tray and grease or fat in the garbage. If the liquid is water, the water can be dumped down the sink before discarding the tray in the garbage.

Any suitable type of meat can be used. Examples include beef, pork, and poultry. The meat could be sliced, for example bacon slices made from pork or turkey. In one example, the meat is turkey bacon slices, and the liquid generated during cooking includes water. In one example, the meat is raw pork bacon slices, and the liquid generated during cooking includes grease. Raw bacon slices means bacon slices that have preferably been cured but have not been fully cooked to a safe temperature (e.g., a minimum internal temperature of 145° F. according to the U.S. Department of Agriculture (USDA)). Therefore, the raw bacon slices could be uncooked or partially cooked. Although raw bacon slices, bacon slices, and bacon are examples of meat used throughout the description, it is recognized that other types of meat could be used. Therefore, raw bacon slices, bacon slices, or bacon could be substituted with any suitable type of meat.

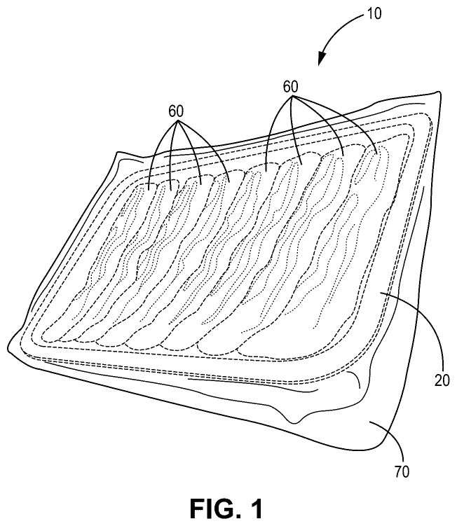

In one example embodiment, illustrated in FIG. 1, an oven ready tray assembly 10 includes one or more meat products (e.g., slices of raw bacon 60 as shown throughout the figures, although it should be known that any prepared meat product may be covered by the disclosure) positioned on an oven ready tray 20 (hereinafter simply referred to as a “tray 20”) and covered by a seal 70. In some embodiments, the bacon 60 may be protected and held in place by the seal 70 which is wrapped around the entire periphery of the tray 20 and the bacon 60.

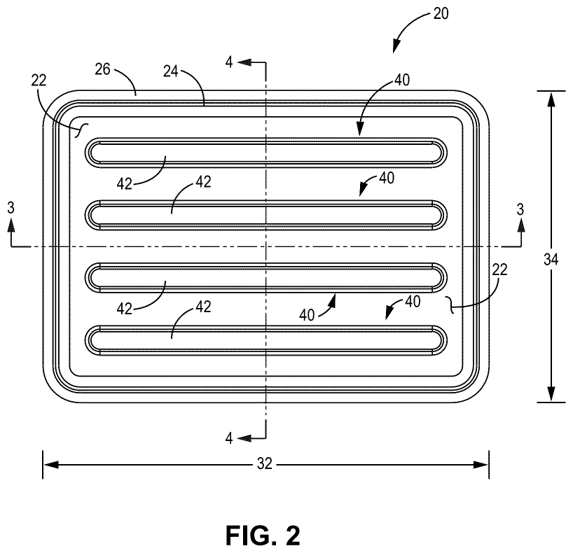

As shown in FIGS. 2-4, in some embodiments, the tray 20 may be any size, shape and configuration to hold the bacon 60 for cooking and survive the cooking environment. In some embodiments as shown in FIG. 2, the tray 20 is substantially rectangular in shape with a length 32 and a width 34 and with radiused corners when viewed from above.

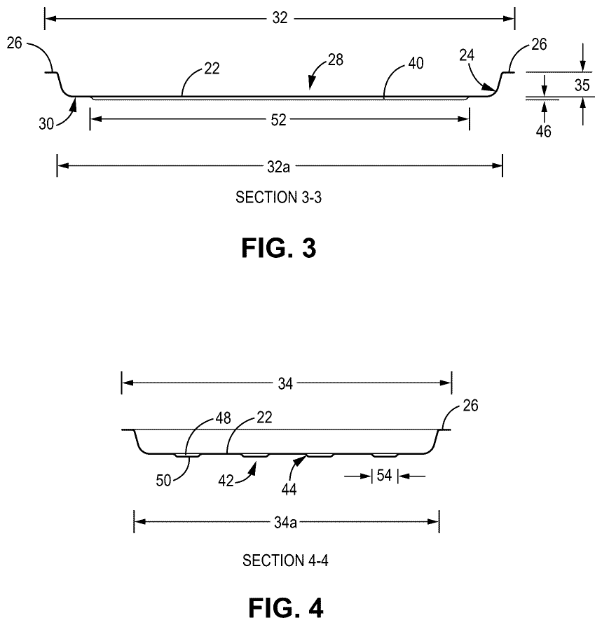

In some embodiments, the tray 20 may include a tray bottom 22 with an inner surface 28 and an outer surface 30. The tray bottom 22 may be any size, shape, and configuration and is configured to provide a platform to hold the bacon 60 from the time it is packaged until the cooking process is complete. In some embodiments, the tray bottom 22 is substantially rectangular in shape with bottom length 32a and bottom width 34a and with radiused corners when viewed from above. In some embodiments as shown in FIG. 3, the tray bottom length 32a is long enough to accommodate eight slices of bacon side by side, although it should be known that other lengths may be used to accommodate more or fewer slices of bacon or other meat products. In some embodiments as shown in FIG. 4, the tray bottom width 34a is wide enough to accommodate the length of a standard slice of bacon, although it should be known that other widths may be used to accommodate different sizes of bacon or other meat products. In some embodiments as shown in FIGS. 3-4, the tray bottom 22 has a length 32a that is about 13- 9/32 inches (about 33.75 cm) and a width 34a that is about 9- 31/32 inches (about 25.32 cm).

In some embodiments, the tray 20 includes sides 24 that extend substantially upwardly from the tray bottom 22. The tray sides 24 may be any size, shape, and configuration and may have any suitable depth 35 to hold an amount of liquid that is generated in the cooking process. In some embodiments, the tray sides 24 have a tray depth 35 at least a height that is higher than a height of a volume of liquid within that is not collected in the wells 40. In some embodiments, substantially upwardly may mean upwardly at any angle from 90-120 degrees from the tray bottom 22 that is appropriate to both hold the liquid within the tray after cooking and to allow the tray to be repeatably manufactured and nested within each other. In some embodiments, substantially upwardly more preferably means about 105 degrees from the tray bottom 22 as shown in FIGS. 3-4. In some embodiments, the tray sides 24 meet the tray bottom 22 at a radius of about ⅜ inches (about 0.95 cm) and extend up to a height of about ¾ inches (about 1.9 cm) from the tray bottom 22.

In some embodiments, a top flange 26 extends outwardly from the tray sides 24. The tray flange may be any size, shape, and configuration suitable to provide a user with a stable place to grab the tray 20 and/or to optionally provide a sealing surface for the seal 70. In some embodiments, the width of the top flange 26 may be 0-1 inches (about 0-2.54 cm) wide, more preferably about 0.5 inches (about 1.27 cm). In some embodiments, the top flange 26 extends outwardly from tray sides 24 at a radius of about 1/16 inches (about 0.16 cm).

In some embodiments, the tray 20 includes at least two depressions or wells 40 extending downwardly from the bottom 22. The wells 40 may be any size, shape, and configuration suitable to hold an amount of liquid generated by the bacon during cooking and provide a number of separate volumes within which to hold the liquid generated during cooking from the volume of the tray 20 defined by the tray bottom 22 and the tray sides 24. The wells 40 have a generally obround shape when viewed from above and have a well width 54 and a well length 52 that extends substantially the length of the tray 20 between the tray sides 24. In some embodiments, substantially the length of the tray 20 means from 80%-100% of the length of the tray bottom 22, more preferably 85%-90% of the length of the tray bottom 22. In some embodiments, the length of the wells 40 is about 11-⅜ inches (about 28.9 cm) and a width of about ¾ inches (about 0.95 cm), reach a depth of about 3/32 inches (about 0.24 cm), are spaced apart by about 1¼ inches (about 3.175 cm), and include radii of about ⅛ inches (about 0.32 cm) between the tray bottom 22 and well bottom 42, and the well sides 44.

In some embodiments, each well 40 includes a well bottom 42, preferably configured and arranged to support the tray 20 on a surface such as a countertop or an oven tray within an oven, and well sides 44 interconnecting the tray bottom 22 and the well bottom 42 which reach downwardly from the tray bottom 22 to a well depth 46. In some embodiments, the well sides 44 are radiused. Like the tray bottom 22, each depression or well 40 includes an inner surface 48 and an outer surface 50 and is of a similar material as the tray 20. In some embodiments, the depressions or wells 40 are formed from the tray bottom 22 and, therefore, the inner surfaces 28 and 48 and the outer surfaces 30 and 50 are the same material or materials.

In some embodiments, the tray 20 includes at least two depressions or wells 40. In the example shown in the figures, there are four depressions or wells 40 that are long enough to accommodate eight slices of bacon 60, and wide enough, deep enough, and spaced to contact four portions of each of the bacon slices 60 with liquid (e.g., grease) generated during cooking within the wells 40. The amount of grease generated during cooking depends upon the type of bacon, the thickness of the bacon, etc. It should be known that the number and dimensions of the wells 40 depends upon the type of meat being cooked (e.g., any number of wells may be included to accomplish the stated goals of preventing the sloshing of the liquid generated during cooking and to provide a number of contact points between the bacon 60 and the liquid during cooking). The dimensions of the wells may be suitable to accommodate contact between the bacon and the liquid such that the bacon cooks partially in the liquid and maintains more moisture, thus preventing overcooking and further reducing the amount of liquid in the tray.

In some embodiments, the tray 20 is made of any suitable material that is repeatably bendable to form repeatable dimensions during the manufacturing process and to survive the cooking process. In some embodiments, the inner and outer surfaces 28 and 30 are made of a unitary single material or may be a composite of different materials. In some embodiments, at least the inner surface 28 is made of a material that does not absorb liquid or stick to the meat. Any suitable material could be used for the tray including oven-safe paper, aluminum, plastic, etc. In some embodiments, the tray is oven-safe at temperatures up to 400° F. In some embodiments, the tray remains intact or uncompromised when exposed to moisture and grease during cooking. In some embodiments, the tray is disposable and/or recyclable.

In some embodiments, the tray 20 is formed from a composite of Uncoated SBS Board (UCSBS) and a clear polyethylene terephthalate (PET) coating, although it should be known that any other combination of paper, paper and plastic, or plastic may be used to accomplish the stated goals of the tray 20. In such embodiments, the PET coating is non-absorbent, which protects the tray from any negative effects from having liquid generated during the cooking process (e.g., moisture wicking to exterior portions of the tray, loss of structural integrity of the tray, and/or any other issues with liquid at high temperatures wicking through the tray) and keeps all of the liquid within the tray where it can be easily disposed of.

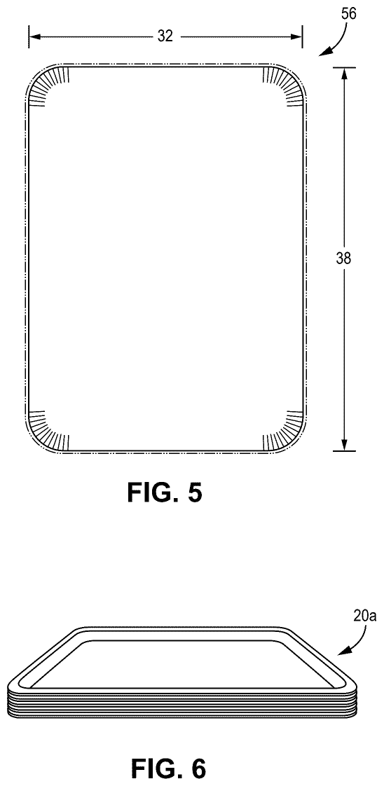

In some embodiments as shown in FIG. 5, to manufacture the tray 20, a tray blank 56 is created (e.g., stamped out of a larger sheet, or any other method known in the art) from the tray material having a blank length 38 and a blank width 36 and the desired radiused corners. The blank 56 then undergoes one or more forming processes whereby the associated tray depth 35 and the well depth 46 are formed into the blank, creating the final form of the tray 20. When formed, each of the trays 20 may be nested within one another as shown in FIG. 6 in preparation for assembling of the oven ready tray assembly 10. In some embodiments, the blank length is about 15.168 inches (about 38.5 cm) and the blank width is about 10.892 inches (about 27.7 cm).

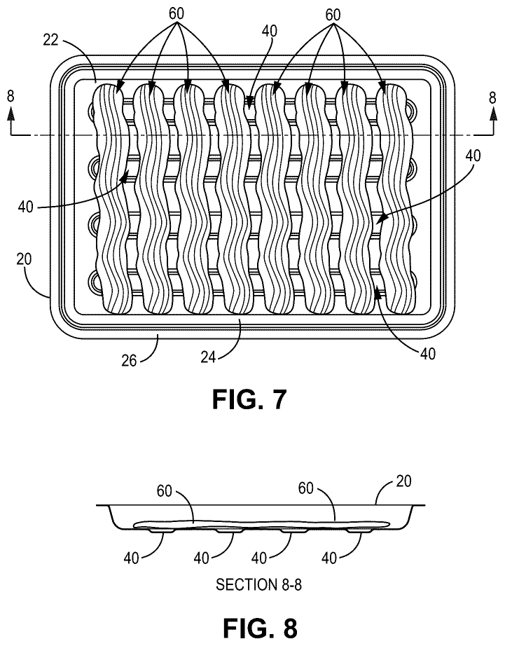

In some embodiments as shown in FIGS. 7-8, one or more meat products like bacon 60 are placed on the formed tray 20. The bacon 60 is placed on the tray bottom 22 such that they reach across all of the wells 40 and are within the well length 52. In the embodiment shown in FIG. 7, there are 8 pieces of bacon 60, although it should be known that this is dependent on the type and size of meat desired to be cooked.

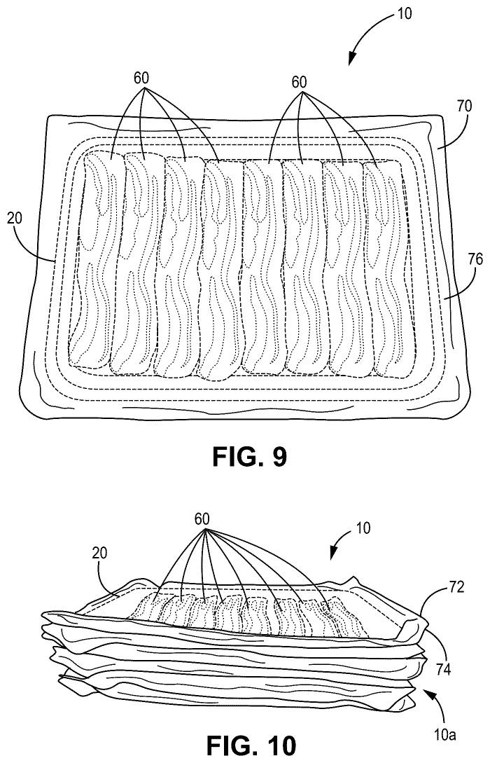

In some embodiments as shown in FIGS. 9-10, a seal 70 is applied to combination of tray 20 and bacon 60. The seal may be any configuration suitable to provide protection to and hold in place the bacon 60 before cooking, and to be easily pulled away from the tray 20 before the cooking process. In some embodiments, the seal 70 comprises first and second film layers 72 and 74 that are connected at a film seal 76 to form an enclosure therebetween in which the bacon 60 is positioned. In still other embodiments, the film layer 72 is operatively connected to the top surface tray top flange 26 and the film seal 76 is therebetween. In some embodiments, a vacuum is pulled, removing any air that is within the seal 70, which tightens the first film layer 72 about the bacon and the tray 20 holding the bacon 60 in place. The sealed assemblies may be nested together in a stack 10a as shown in FIG. 10 for more efficient storing and/or shipping for sale to consumers.

In some embodiments, the oven ready tray 10 begins with the process to form the tray 20. The tray blank 56 is placed within tooling specially made to form the tray sides 24 and wells 40 and prepare to accept the bacon 60. Once the bacon 60 is properly placed on the bottom 22 of the tray 20, the tray 20 with the bacon 60 is sealed for packing and shipping to outlets for sale to consumers.

Once the oven ready tray assembly 10 is purchased by a consumer and ready for cooking, the seal 70 is removed from the oven ready tray assembly 10, leaving only the tray 20 and the bacon 60. The tray 20 with the bacon 60 is then ready to simply put in the oven for cooking without the user needing to handle the bacon 60. After cooking, the tray with the now cooked bacon 60 and an amount of liquid generating by the cooking process is removed from the oven. The cooked bacon 60 may be removed from the tray 20, and the tray with the liquid generated during cooking may be discarded or recycled. In some embodiments, the amount of liquid generated during the cooking process is less than 50 mL.

In other embodiments, a user could obtain a tray 20 and bacon 60 separately and position the bacon 60 on the tray 20 prior to placing the assembly in an oven.

The assembly allows for optimal cooking of meat. The bacon cooks in contact with its own liquid generated during cooking without being submerged in that liquid. Because the meat is at least partially in contact with liquid, the meat cooks more evenly and crispier. Another advantage is that the liquid generated during cooking is partitioned between the tray 20 and within the wells 40. This breaks up the total amount of liquid held within the tray 20 and prevents large swells of liquid from forming like that within a homogenous container, which helps a user to discard the liquid without it sloshing around in an uncontrollable manner. If the liquid is grease or fat, the grease or fat will at least partially solidify or congeal at room temperature thereby allowing for easy clean up by simply discarding the tray and grease or fat in the garbage after cooling and congealing. If the liquid is water, the water can be dumped down the sink before discarding the tray in the garbage.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An oven ready tray for use in cooking a meat product, comprising:
a tray comprising:
a bottom having a first end and a second end, and a first side and a second side;
a sidewall extending upwardly from a perimeter of the bottom;
an outer lip extending outwardly from a perimeter of the sidewall;
wherein the bottom comprises:
a holding surface configured to hold the meat product and extending from the first side to the second side; and
a plurality of depressions extending downwardly from the holding surface and extending substantially from the first end to the second end and configured to collect and separate liquid generated during cooking of the meat product.

2. The oven ready tray of claim 1, further comprising a vacuum sealed enclosure to hold the meat product stationary before cooking.

3. The oven ready tray of claim 1, wherein the oven ready tray comprises materials that are non-degradable to at least 400° F.

4. The oven ready tray of claim 1, wherein the tray comprises a laminate material having at least a paper product laminated in a plastic material.

5. The oven ready tray of claim 4, wherein the paper product comprises uncoated SBS board (UCSBS) and the plastic material comprises a clear polyethylene terephthalate (PET).

6. The oven ready tray of claim 1, wherein the sidewall extends ½″-¾″ upward from the holding surface.

7. The oven ready tray of claim 1, wherein the outer lip extends approximately ¼″-½″ outwardly from the sidewall.

8. The oven ready tray of claim 1, wherein the sidewall extends upwardly and outwardly from bottom such that the tray is configured to receive a second oven ready tray in a nested fashion.

9. The oven ready tray of claim 1, wherein the plurality of depressions comprises four depressions.

10. The oven ready tray of claim 1, wherein the tray is configured to hold up to 50 mL of liquid.

11. An oven ready tray assembly, comprising:
a tray having a bottom and a sidewall around a perimeter of the bottom extending upwardly from the bottom, wherein the bottom further comprises a holding surface and at least two channels that reach downwardly from the holding surface and extend from proximal a first end to proximal a second end of the bottom; and
wherein the at least two channels are configured to capture and separate liquid resulting from cooking a meat product, wherein the meat product is placed from proximal a first side to proximal a second side of the bottom and rests on the holding surface.

12. The oven ready tray assembly of claim 11, further comprising a vacuum sealed protective film configured to surround the tray and hold the meat product in place.

13. The oven ready tray assembly of claim 11, further comprising a tab extending outwardly from a perimeter of the sidewall.

14. The oven ready tray assembly of claim 11, wherein each of the at least two channels are separate from one another.

15. The oven ready tray assembly of claim 14, wherein the at least two channels comprises four channels.

16. A method of cooking meat, comprising:
providing a tray having a bottom and a sidewall around a perimeter of the bottom extending upwardly from the bottom, with a meat product placed on the bottom and a protective film surrounding the tray, the bottom including a holding surface and a plurality of depressions extending downwardly from the holding surface;
removing the protective film from the tray;
placing the tray in a cooking appliance;
cooking the meat product on the holding surface; and
separating and holding liquid generated by the cooking the meat product step within the plurality of depressions, with the meat product contacting at least a portion of the liquid collected in the plurality of depressions during cooking.

17. The method of claim 16, wherein the plurality of depressions is four depressions.

18. The method of claim 16, wherein the meat product is a plurality of bacon slices.

19. The method of claim 18, wherein the plurality of depressions is four depressions, and the plurality of bacon slices is eight bacon slices.

20. The method of claim 16, wherein the removing the protective film from the tray step comprises at least one of:
peeling film off of the tray; and
peeling a first layer of film apart from a second layer of film, the first and second layers of film forming an enclosure in which the tray and the meat product are positioned.
